(19) United States
(12) Patent Application Publication
(10) Pub. No.: US 2009/0211396 A1
(43) Pub. Date: Aug. 27, 2009

(54) DIFFERENTIAL HOUSING AND PRODUCTION METHOD

(75) Inventors: Peter Gutmann, Munchen (DE); Lars Wurker, Hannover (DE)

Correspondence Address: KATTEN MUCHIN ROSENMAN LLP, 575 MADISON AVENUE, NEW YORK, NY, 10022-2585, US

(73) Assignee: SONA BLW PRAZISIONSSCHMIEDE GMBH, Munchen (DE)

(21) Appl. No.: 12/158,496

(22) PCT Filed: Dec. 19, 2006
(86) PCT No.: PCT/EP2006/012211

§ 371 Date: Oct. 27, 2008

(30) Foreign Application Priority Data
Dec. 22, 2005 (DE) 10 2005 062 017.5

(51) Int. Cl. F16H 57/02; F16B 5/04

(52) U.S. Cl. 74/607; 29/524.1

(57) ABSTRACT

Disclosed is a differential housing (1) comprising a housing bell (5) and a housing cover (4). The housing bell and the housing cover are connected to each other by means of a riveted joint (7) that is established by means of several rivets (8). The rivets of the riveted joint are monolithically molded onto the housing cover or the housing bell.

The present invention relates to a differential housing which includes a housing bell and a housing cover, where the housing bell and the housing cover are connected to one another by means of a riveted joint consisting of several rivets, as well as a method for its production and installation.

A differential housing is used for the accommodation and operation of the components of a differential drive, which usually consists of the bevel gears and pinions forming the differential gear, as well as the driving gear or ring gear driven by the drive mechanism. Furthermore, such a differential housing exhibits on two sides which are opposite one another, preferably in the housing cover and in the housing bell, openings for the driven shafts projecting coaxially from the housing on different sides. The housing cover and the housing bell of a completely installed differential housing are, according to the state of the art, connected to one another in a professionally acceptable manner by means of a plurality of threaded bolts or rivets distributed over the area of the housing.

The construction space available for a differential gear and a differential housing has extremely small dimensions in a passenger automobile, especially one with front-wheel drive, so that savings in construction space are desirable even in the range of a few millimeters. Moreover, the installation of a differential housing of this type, whose housing components are connected by means of ordinary riveted joints, requires several working steps. The housing components to be connected must in every case, to the requisite degree of precision for passage, be furnished with appropriate drilled holes for the rivets, and before the rivets are passed through the drilled holes of the two housing components, they must be exactly centered with respect to each other by means of centering pins. In addition, the rivets on the two sides of the components to be connected to one another require construction space for the rivet closing head on one side and the rivet setting head on the other side.

Considered with this background, it is the task of the present invention to eliminate the disadvantages described above and to make available a differential housing of the type described initially which saves space, is stable, and is simple to produce, as well as an appropriate method for its production and installation.

This task is accomplished in accordance with the invention by means of a differential housing in accordance with claim 1 and a method for its production and installation in accordance with claim 7.

The differential housing in accordance with the invention is distinguished by the fact that the rivets forming the riveted joint between the housing cover and the housing bell are monolithically molded onto the housing cover or the housing bell. In the method in accordance with the invention the raw rivets molded onto the housing cover or the housing bell are, in order to install the differential housing, conveyed with their free end through the drilled holes made for them in the other housing component, and thereafter their free ends are reshaped—by means of reshaping techniques which in and of themselves are known—to form the riveted joint.

In this way, in a differential housing in accordance with the invention, the production of the riveted joint does not require any separate rivets. The appropriately shaped raw rivets and the drilled holes assigned to them determine the relative position of the two housing components of the differential housing, and therefore in their installation it is possible to dispense with separate centering pins. Furthermore, the housing component onto which the raw rivets are monolithically molded does not have to be furnished with drilled holes for separate rivets. What is more, in a differential housing in accordance with the invention—unlike the case of a conventional riveted joint—on that side of the housing component fitted with shaped rivets which is away from the riveted joint there are no setting heads or closing heads that interfere in the case of a conventional riveted joint, and this signifies a not inconsiderable saving of space.

The multi-component differential housing in accordance with the invention may be made of steel or other suitable metals and/or alloys, for example aluminum or other light construction metals. Even though the expression “monolithically molded” chosen in characterizing the formation of the rivets is to be understood preferably as a monolithic molding of the same material, in some cases when a differential housing in accordance with the invention is used it is also possible to have entire rivets made of another material, or reinforcements made of another material running inside shaped rivets, and/or a coating of the rivets that improves the riveted joint. The usual casting and/or reshaping techniques, such as forging for example, are suitable for the production of the housing components and of the rivets monolithically molded onto a housing component.

The differential housing in accordance with the invention makes possible a high degree of flexibility in the exact arrangement of the raw rivets monolithically molded onto the housing cover or the housing bell.

Although in principle cylindrical raw rivets may also be provided, nevertheless, in a first preferred embodiment of the invention, the raw rivets exhibit a conical shape which extends over their axial length. In such cases it is preferable to provide a cone angle in the range of 0° to 5°, or, again preferably, in the range of 0.5° to 5°.

The conical shaping of the raw rivets gives them better “foot strength” in the area of their molding onto the housing cover or the housing bell. Furthermore, the conical shape of the raw rivets makes it easier to pass them through the corresponding drilled holes of the other housing component and thereby facilitates their centering in the correct position. In the actual production of the riveted joint, during the reshaping process of the rivet head, the entire—initially still conically shaped—rivet shaft is so clenched and deformed that it is possible in the preferably cylindrical drilled holes of the other housing component to achieve good contact in the area of bearing pressure on the interior of the hole, which leads to a strong force fit of the riveted joint.

According to one preferable further development of the invention, it can be provided that the raw rivets molded onto the housing cover or the housing bell exhibit along their axial length two regions with different cone angles. These cone regions may be immediately adjacent to one another and form an angle or may, preferably, transition into one another in a continuous manner. Apart from this, it may be provided that the raw rivets exhibit a chamfer at their free end. The conicity of a raw rivet may also increase continuously along its total axial length to its free end.

If there are several cone regions, or if there is one continuously running conicity of the rivets, it is possible, with suitable cone angles, to improve the centering of the two housing components with respect to one another even further when they are installed. Furthermore, with a conicity that increases—continuously or stepwise—the size of the closing head—which is created by the deformation of the free end of the rivet—can be reduced, and this is found to be advantageous, especially if there is scanty construction room. The reason is that in a riveted joint it is not the thickness or the diameter of the closing head that is of decisive importance; instead, we create the force fit largely by the pressure of the rivet on the interior wall of the drilled hole.

According to a further preferred embodiment of the present invention, the housing cover, the housing bell, and the rivets which have been monolithically molded onto the cover or the bell are made of aluminum or an aluminum alloy. The well-known casting or deformation techniques, such as forging, for example, are suitable for this. It has been found that raw rivets made of aluminum and monolithically molded onto the housing cover or the housing bell provide a preliminary tension suitable for the purpose at hand between the housing components during the production of the riveted joint. The deformation process for the creation of the closing head on a rivet provides a certain heating of the rivet during the production of the riveted joint, so that the subsequent cooling process and the shrinking that takes place in the course of that process can give rise to a suitable preliminary tension.

Through forging of the housing components and through the use of fitted raw rivets, it is possible to ensure excellent material properties for a differential housing in accordance with the invention. It is found, however—especially for reasons associated with cost, among others—to be especially advantageous if the housing cover, the housing bell, and the shaped raw rivets are reduced by the so-called counter pressure casting method. This production process, which is known to those skilled in the art as a common one, guarantees particularly low microporosity of the working material, which not only provides an even stronger force fit but at the same time also provides a high elastic limit and good ductility. These material properties are, in particular, factors in favor of the aforementioned riveted joint to the extent that they make it possible to achieve an even stronger force fit of the riveted joint.

A further advantageous embodiment of the invention provides a heating of the raw rivets, before the actual production of the riveted joint, by deformation of the free ends of the rivets. This can, as a result of the arrangement of the differential housing in accordance with the invention, be brought about quite simply by virtue of the fact that the housing components onto which the rivets are monolithically molded are appropriately heated. As a result, it is possible—with adjustments to the material properties in each case—to increase once again the preliminary tension of the riveted joint. The reason is that as a result of the higher material temperature when the riveted joint is created, a higher preliminary tension is produced during the subsequent cooling process than is the case when the initial temperature is lower.

Lastly, in the differential housing in accordance with the invention it is preferable to have the driving gear fastened between the housing cover and the housing bell in a torque-proof manner by means of the raw rivets molded onto one housing component. For this purpose, appropriate drilled holes for passing the rivets through should be made in the driving gear as well. Here also, the preliminary tension of the riveted joint makes for a particularly good attachment of the driving gear between the housing components of the differential housing. In addition, the installation is again facilitated to the extent that the relative position of the driving gear with respect to the two housing components is determined in advance by the rivets monolithically molded onto one housing component and by the drilled holes in the gear and the other housing component.

As a further advantage of the differential housing in accordance with the invention, it is found that the shaped rivets in an advantageous embodiment of the invention can also be constructed along their axial extent with a shape that deviates from rotational symmetry. In this arrangement the cross sections of the drilled holes in the other housing component and, if need be, in the driving gear must be appropriately adapted to the asymmetric shape of the rivets. Apart from this, the free end of the raw rivets may be made either flat, convex, or concave, as needed.

In what follows the invention will be elucidated more clearly with the aid of the drawing. Here

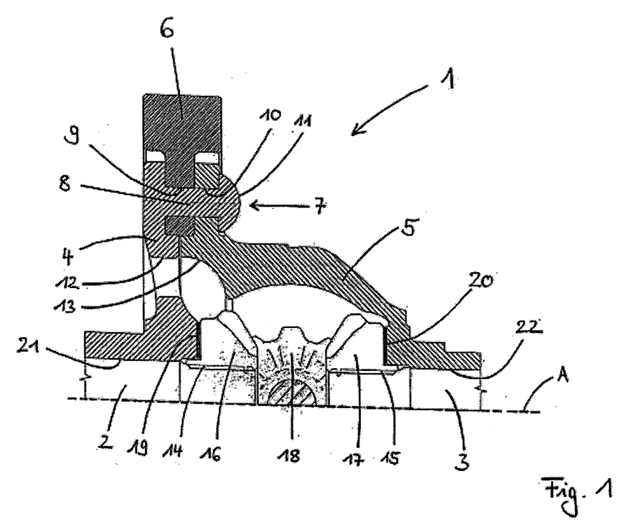

FIG. 1 shows a half cross section through one design example of the arrangement of an installed differential housing in accordance with the invention,

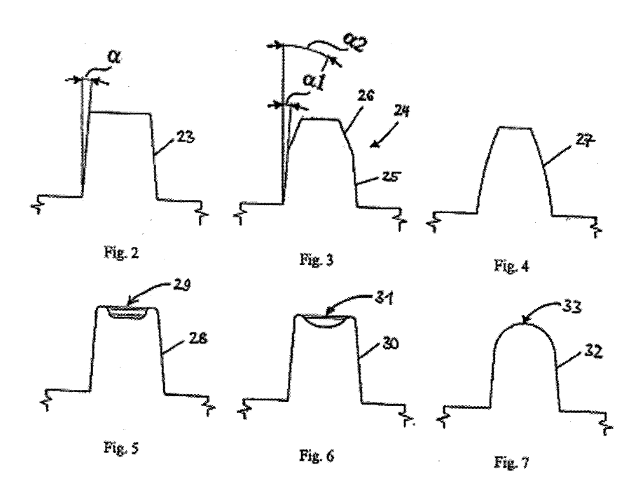

FIGS. 2 through 7 show schematic views of five different designs of an appropriately shaped raw rivet, and

FIGS. 8 through 14 show detailed cross-sectional representations of various appropriately shaped riveted joints.

FIG. 1 shows a half cross section of a design example of a differential housing 1 in accordance with the invention, where the cutting plane runs through the axis A of the two coaxial driven shafts 2, 3 and thus runs through the middle of the equalizing gear. The differential housing 1 consists of a housing cover 4 and a housing bell 5, between which the driving gear 6 is fastened in a torque-proof manner by means of a riveted joint 7. The riveted joint 7 consists of several monolithically molded rivets which are distributed over the area of the housing and are each connected to the housing cover 4, only one rivet 8 being represented in the section in FIG. 1. The free end of the rivet 8 which is monolithically molded onto the housing cover 4 was—before the reshaping of the free end of the raw rivet in order to produce the riveted joint 7—first passed through a drilled hole 9 in the driving gear 6 and a drilled hole 10 in the housing bell 5, as a result of which the structural parts to be connected were, at the same time, centered to the correct position with respect to one another. Thereafter the free end was deformed in a professionally acceptable manner to produce the riveted joint 7, as a result of which the closing head 11 was formed on the rivet 8.

The housing cover 4 and the housing bell 5 form corresponding lubricating-oil channels 12, 13 for supplying the equalizing gear with lubricating oil. The bevel gears 16, 17, connected in a torque-proof manner to the driven shafts 2 and 3, respectively, through a plug-in connection 14 and 15, respectively, mesh from different sides with two pinions positioned at the housing bell, and of these, as a result of the chosen sectional plane in FIG. 1, only one pinion 18 can be recognized in the front view. The bevel gears 16, 17 are, at their end opposite the toothing, positioned next to the adjacent housing component 4 and 5, respectively, by means of appropriate spacers 19, 20. The coaxially running driven shafts 2, 3 emerge from the differential housing 1 on different sides. For this purpose, an opening 21 in the middle of the housing cover 4 and an opening 22 in the middle of the housing bell 5 are provided, and the driven shafts 2, 3 are positioned rotatably in them.

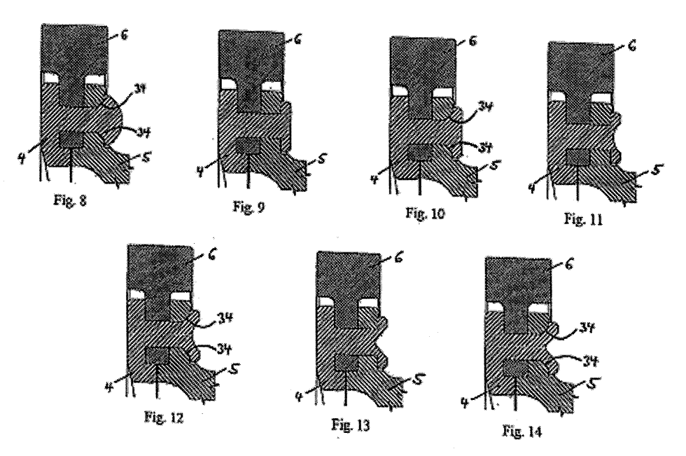

FIGS. 2 through 7 show schematic views of five different designs of a raw rivet of a differential housing in accordance with the invention which can be monolithically molded onto the housing cover or the housing bell. The rivet 23 of FIG. 2 is shaped conically and has the same constant cone angle α throughout its entire axial length. In contrast, the rivet 24 of FIG. 3 exhibits in its conical extent over its axial length two regions, 25, 26 immediately adjacent to one another and having different cone angles α1 and α2. Lastly, FIG. 4 shows a further arrangement of a rivet 27 whose conicity increases steadily and continuously to its free end. While the free end of the rivets of FIGS. 2 through 4 lies in one plane—with respect to the surface onto which they are monolithically molded—the rivets 28, 30, and 32 of FIGS. 5 through 7 show a different arrangement of their free end. The free end 29 of the rivet 28 in FIG. 4 is shaped concave, as is the free end 31 of the rivet 30 in FIG. 6. The rivets of FIGS. 5 and 6 differ only in the specific shaping of the concave end of the rivet concerned. In contrast, the rivet 32 in FIG. 7 is shaped with a convex free end 33, where the transition between the rivet shaft and the free end takes place in a continuous manner.

With the flexibility represented with the aid of FIGS. 2 through 7, in the specific shaping of the raw rivet, the riveted joint created by deformation of the free end of the raw rivet can be adapted flexibly to the requirements of each case. In particular, the increased conicity represented in FIGS. 3 and 4 in the area of the free end of the raw rivets 24 and 27 makes it possible to reduce the size of the closing head created after the production of the riveted joint. With the concave design of the free end of the raw rivets 28, 30 of FIGS. 5 and 6, respectively, when an appropriately shaped deformation tool is used, the material flow in the deformation of the free end of the raw rivet can be optimized, so as to increase the pressure on the interior wall of the hole and therefore improve the force fit of the finished riveted joint.

Lastly, FIGS. 8 through 14 show still further detailed representations of various riveted joints of further design examples of a differential housing in accordance with the invention. In these illustrations, in all the detailed representations of FIGS. 8 through 14 the housing cover 4, the driving gear 6, and the housing bell 5 are connected to each other with rivets monolithically molded onto the housing cover 4, as has already been made clear with the aid of FIG. 1. The riveted joints represented differ only in the fact that in FIGS. 8, 10, 12, and 14 the drilled holes in the housing bell, on the side on which the closing head of the rivet is situated, exhibit a bevel 34, by means of which the force fit of the riveted joint is improved. Furthermore, the closing head of the rivet in FIG. 8—like the one in FIG. 1—is convex, in contrast with which the closing heads of the riveted joints in accordance with FIGS. 9 and 10 are made flat and those in FIGS. 11 through 14 are made concave.

1. Differential housing, embodying a housing bell and a housing cover, wherein the housing bell and the housing cover are connected to one another by means of a riveted joint produced by means of several rivets,
characterized in that
the rivets of the riveted joint are monolithically molded onto the housing cover or the housing bell.

2. Differential housing in accordance with claim 1,
characterized in that
the raw rivets molded onto a housing component exhibit a conical form.

3. Differential housing in accordance with claim 2,
characterized in that
the cone angle lies in a range between 0° and 5°.

4. Differential housing in accordance with claim 2,
characterized in that
the raw rivets exhibit over their axial length two regions with different cone angles.

5. Differential housing in accordance with claim 1,
characterized in that
the housing cover, housing bell, and rivets are made of aluminum or an aluminum alloy.

6. Differential housing in accordance with claim 1,
characterized in that
by means of the shaped rivets the driving gear is fastened in a torque-proof manner between the housing cover and the housing bell.

7. Differential housing in accordance with claim 1,
characterized in that
the raw rivets are not rotationally symmetric in a section perpendicular to their axial direction.

8. Method for the production and installation of a differential housing in accordance with claim 1,
characterized in that
the raw rivets molded onto the housing cover or the housing bell are passed with their free end through drilled holes assigned to them in the other housing component, and their free ends are then deformed in order to create the riveted joint.

9. Method in accordance with claim 8,
characterized in that
the housing components of the differential housing are centered with respect to one another when the raw rivets are passed through.

10. Method in accordance with claim 8,
characterized in that
the housing cover, the housing bell, and the raw rivets molded onto them are cast or forged from aluminum or an aluminum alloy.

11. Method in accordance with claim 10,
characterized in that
the housing cover, the housing bell, and the raw rivets molded onto them are produced by the counter pressure casting process.

12. Method in accordance with claim 8,
characterized in that
the raw rivets are preliminarily heated before the production of the riveted joint.
